(19) United States
(12) Patent Application Publication
(10) Pub. No.: US 2004/0221025 A1
(43) Pub. Date: Nov. 4, 2004

(54) Apparatus and method for monitoring computer networks

(76) Inventors: Ted C. Johnson, Issaquah, WA (US); Lori Ann Nestor, Bessemer, AL (US); Victor H. Williams, Lawrenceville, GA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/425,408

(22) Filed: Apr. 29, 2003

(51) Int. Cl. G06F 15/173

(52) U.S. Cl. 709/223

(57) ABSTRACT

The disclosure relates to a system and method for monitoring a computer network that comprises a plurality of computers. The system may comprise a network monitor associated with each of the plurality of computers, the network monitor being adapted to monitor error data for a communication channel, compare the error data with at least one pattern corresponding to an associated problem, and provide notification of the associated performance problem if the error data corresponds to the at least one pattern.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Since the introduction of the first personal computer (“PC”) over 20 years ago, technological advances to make PCs more useful have continued at an amazing rate. Microprocessors that control PCs have become faster and faster, with operational speeds eclipsing a gigahertz (one billion operations per second) and continuing well beyond.

Productivity has also increased tremendously because of the explosion in the development of software applications. In the early days of the PC, people who could write their own programs were practically the only ones who could make productive use of their computers. Today, there are thousands and thousands of software applications ranging from games to word processors and from voice recognition to web browsers.

### a. The Evolution of Networked Computing

In addition to improvements in PC hardware and software generally, the technology for making computers more useful by allowing users to connect PCs together and share resources between them has also seen rapid growth in recent years. This technology is generally referred to as “networking.” In a networked computing environment, PCs belonging to many users are connected together so that they may communicate with each other. In this way, users can share access to each other's files and other resources, such as printers. Networked computing also allows users to share Internet connections, resulting in significant cost savings. Networked computing has revolutionized the way in which business is conducted across the world.

Not surprisingly, the evolution of networked computing has presented technologists with some challenging obstacles along the way. One obstacle is connecting computers that use different operating systems (“OSes”) and making them communicate efficiently with each other. Each different OS (or even variations of the same OS from the same company) has its own idiosyncrasies of operation and configuration. The interconnection of computers running different OSes presents significant ongoing issues that make day-to-day management of a computer network challenging.

Another significant challenge presented by the evolution of computer networking is the sheer scope of modem computer networks. At one end of the spectrum, a small business or home network may include a few client computers connected to a common server which may provide a shared printer and/or a shared Internet connection. On the other end of the spectrum, a global company's network environment may require interconnection of hundreds or even thousands of computers across large buildings, a campus environment, or even between groups of computers in different cities and countries. Such a configuration would typically include a large number of servers, each connected to numerous client computers.

Further, the arrangements of servers and clients in a larger network environment could be connected in any of a large number of topologies that may include local area networks (“LANs”), wide area networks (“WANs”) and municipal area networks (“MANs”). In these larger networks, a problem with any one server computer (for example, a failed hard drive, corrupted system software, failed network interface card or OS lock-up to name just a few) has the potential to interrupt the work of a large number of workers who depend on network resources to get their jobs done efficiently. Needless to say, companies devote considerable time and effort to keep their networks operating trouble-free to maximize productivity.

### b. Networking Protocols

For computers in a networked environment to communicate with each other, each computer is typically equipped with a device known as a network interface card or “NIC.” The NIC is used to send messages or packets to other computers on the network and to receive messages or packets received from other computers. NICs operate according to a specific protocol or set of rules, which govern various aspects of their communication capability.

Some networking protocols may be used in conjunction with other protocols because they relate to different aspects of network communication. For example, one common network protocol is the Ethernet protocol. The Ethernet protocol relates to the physical connections and signaling formats that are used for communication to take place. For two NICs (and, thus, the computers or other devices associated with those NICs) to be able to exchange messages using the Ethernet protocol, both NICs are programmed to meet all the requirements specified by the Ethernet protocol.

Two other protocols that may be used to organize communication in an Ethernet network are the Transmission Control Protocol (“TCP”) and the Internet Protocol (“IP”). The TCP protocol relates to the way in which data is broken down and placed in smaller increments, which may be known as packets, for transmission. The IP protocol relates to how packets are addressed and delivered in a network environment. The TCP and IP protocols are frequently used together, and may be collectively referred to as the TCP/IP protocol. The Internet is an example of a network that exchanges information according to the TCP/IP protocol.

### c. The Development of 10 Mbps and 100 Mbps Ethernet Networks for TCP/IP

When 10 megabit per second (“Mbps”) Ethernet was first developed for TCP/IP, networks could be implemented using a shared bus topology. In other words, all NICs were connected together using the same Ethernet or local area network (“LAN”) cable. The shared bus Ethernet cable could be connected to the Internet using a device such as a router.

In a 10 Mbps Ethernet network, a computer desiring to start a communication with another computer could simply start writing data to the LAN bus. If another computer is using the bus at the same time, then a packet collision could occur. This collision could be detected by the NIC cards of both sending computers because the voltage level on the bus would be a multiple of the typical level if only one computer was using the bus. 10 Mbps networks had no capability for collision avoidance. In other words, the 10 Mbps Ethernet architecture was designed to take into account that collisions would occur as a normal and expected part of their operation. This characteristic of 10 Mbps NICs may be referred to as CSMA/CD, which stands for Carrier Sense Multiple Access with Collision Detection.

When a collision occurs, the NICs that are attempting to send data are designed to stop transmitting and wait for different random time periods. After waiting for a random time period, each NIC would try again to send its data. Whichever NIC resumes sending data could continue to send data until it runs out of data to send or another packet collision occurs.

10 Mbps Ethernet networks are referred to as “half duplex,” which means that communication is possible in only one direction at a time. In other words, a 10 Mbps Ethernet NIC is not designed to transmit information and simultaneously receive information from another 10 Mbps Ethernet NIC.

In the late 1990s, 100 Mbps TCP/IP network devices, including NICs, were developed. These 100 Mbps network devices are able to exchange information at up to 10 times the speed of 10 Mbps network devices. Network switches were developed with the ability to accommodate both 10 Mbps and 100 Mbps network devices. The 100 Mbps devices could be connected to the network switch using a star topology instead of the shared bus topology employed by 10 Mbps systems. In a star topology, each 100 Mbps network device is connected directly to the network switch. In this configuration, collision between data packets is no longer a problem because only one device is connected to each line from the network switch. In other words, there are no longer multiple devices generating potentially colliding packets on a shared bus. Because the network architecture of 100 Mbps results in the avoidance of collisions instead of their detection, 100 Mbps networks are referred to as CSMA/CA, which stands for Carrier Sense Multiple Access with Collision Avoidance.

Another benefit of the use of the star topology for 100 Mbps network devices is that it facilitates the use of full duplex communication. In other words, a 100 Mbps network device, such as a NIC, has the ability to transmit and receive data simultaneously.

### d. Automatic Configuration of Network Devices

As is apparent from the foregoing discussion, network devices, such as NICs, are relatively complicated devices that may have a large number of configuration settings. These settings may be subject to adjustment to facilitate communication on different types of network environments. Configuration settings may be manually changeable or, in some cases, automatically changeable. The ability of network devices to configure automatically themselves according to network conditions may be a valuable characteristic. Automatically configurable devices may save network maintenance support personnel considerable time and effort in setting up or maintaining a computer network. Devices that have the capability to configure themselves automatically (sometimes referred to as “autoconfiguration”) may also be convenient to deploy because such devices may be placed in out-of-the-way locations such as closets or the like where physical access is difficult. Network devices may not be able to be placed in such locations if they must be physically accessed to adjust their configuration settings.

One configuration setting for many NICs is the speed at which data is transmitted. A network switch, which may be designed to accommodate both 10 Mbps and 100 Mbps network devices, may have the ability to determine automatically the transmission speed capability of NICs connected to it and designate a particular connection as being best suited for one speed or another speed. For example, when a network switch is initialized, it may go through a process of evaluating each of its connection ports and determining whether each port is configured for 10 Mbps communication or 100 Mbps communication. This decision may depend on the type and speed of network devices connected to each communication port. Ethernet devices designed for faster communication, such as 100 Mbps devices, are typically also able to operate at slower speeds, such as 10 Mbps, to allow them to be used in slower networks. Slower devices, however, do not have the capability to communicate at faster speeds. In addition to determining the speed of a given network connection, an autoconfiguration switch may also attempt to determine whether the connection is half-duplex or full-duplex.

The process by which a network switch automatically configures the speed and duplex setting of its communication ports is referred to as “autonegotiation.” A potential problem with autonegotiation is that it may not always work correctly. A variety of factors may determine the likely success of a given autonegotiation configuration. One of these factors may be whether all the networking hardware that is being evaluated in a given autonegotiation transaction (e.g the network switch and NICs connected to a specific port) is made by the same vendor.

Autoconfiguration is prone to failure because the specification for autoconfiguration was written with insufficient precision. This resulted in different vendors interpreting and implementing the autonegotiation protocol is slightly different ways. Thus, autoconfiguration usually works when all of the hardware is from the same vendor, but frequently fails in a mixed vendor environment. If networking equipment is made by the same vendor, autonegotiation is more likely to occur correctly.

On the other hand, if networking hardware is purchased from multiple vendors, then autonegotiation may not work correctly. For example, if a data center has a network switch from a first manufacturer connected to computers with NICs produced by a different manufacturer, the switch may not be able to configure its communication ports correctly through autonegotiation. If autonegotiation fails to work properly, the performance of the network may be compromised or degraded.

If autonegotiation does not work correctly, a network switch may incorrectly configure the transmission speed or communication type (half-duplex or full-duplex) of one or more of its communications ports. For example, a communication port that is connected to a network segment that has only 10 Mbps, half-duplex NICs may be incorrectly configured by the switch to operate at 100 Mbps in full-duplex mode.

If such an error occurs, a switch port may be incorrectly configured to transmit and receive data simultaneously (full-duplex mode) because the NICs connected to that port may be capable only of half-duplex operation. The computer host of the NIC may be unable to send data for extended periods of time because it cannot do so while it is receiving data from the switch. For example, if both the switch and the computer have data to send to each other, there may be two packets of data on the line simultaneously. This is true because the switch, which is configured for full-duplex transmission, will not wait to send its data even though the computer, which is configured for half-duplex operation, is sending data.

If this situation occurs, the half-duplex computer NIC may detect the collision and cease transmission of its data. After a suitable random interval, the computer may again try to send its data, but may again detect a collision because the switch does not stop transmitting data when a collision occurs. If the computer (NIC) is employing an algorithm, such as backoff congestion avoidance (which doubles the wait time between successive send attempts), the computer will delay trying to send successive transmissions for longer and longer periods of time with each detected collision. In large networking environments, there may be many occurrences of this type of misconfiguration, which will result in significant system performance degradation. For example, transactions that might otherwise take about five seconds may take over two minutes to complete. The risk of reduced performance is particularly great in network environments that have a large number of both 10 Mbps and 100 Mbps NICs.

Not all of the duplex/speed mismatches are the result of autonegotiation failures. Sometimes network personnel attempt to avoid autonegotiation problems by overriding the autonegotiation process, by manually configuring the switch and the NIC to matching values (e.g., 10 Mbps half-duplex on both ends). This is called “hard-wiring” or “nailing” the switch and NIC. When done correctly, it solves the issue. But when the switch and NIC are nailed to incompatible values, the resulting network degradation is just as problematic as when the mismatch is a result of an autonegotiation failure.

It is time consuming and requires significant resources to detect and correct speed and duplex misconfiguration problems manually. Indeed, to do so significantly reduces the benefit that autonegotiation provides. The time-consuming process of manually troubleshooting speed and duplex mismatches is further compounded if networking equipment, such as network switches, are deployed in locations that are difficult to access physically (wiring closets, for example). Even if ports on network switches can be corrected remotely (for example, through a browser or telnet interface), configuration mistakes, such as changing the settings on the wrong port, may create more configuration problems.

### SUMMARY OF THE INVENTION

The disclosure relates to a system and method for monitoring a computer network that comprises a plurality of computers. The system may comprise a network monitor associated with each of the plurality of computers, the network monitor being adapted to monitor error data for a communication channel, compare the error data with at least one pattern corresponding to an associated problem, and provide notification of the associated performance problem if the error data corresponds to the at least one pattern.

### BRIEF DESCRIPTION OF THE DRAWINGS

Advantages of one or more disclosed embodiments may become apparent upon reading the following detailed description and upon reference to the drawings in which:

FIG. 1 is a block diagram illustrating a computer network in accordance with an embodiment of the present invention;

FIG. 2 is a block diagram of a network switch and associated network segments in accordance with an embodiment of the present invention; and

FIG. 3 is a process flow diagram that is useful in explaining the operation of an embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

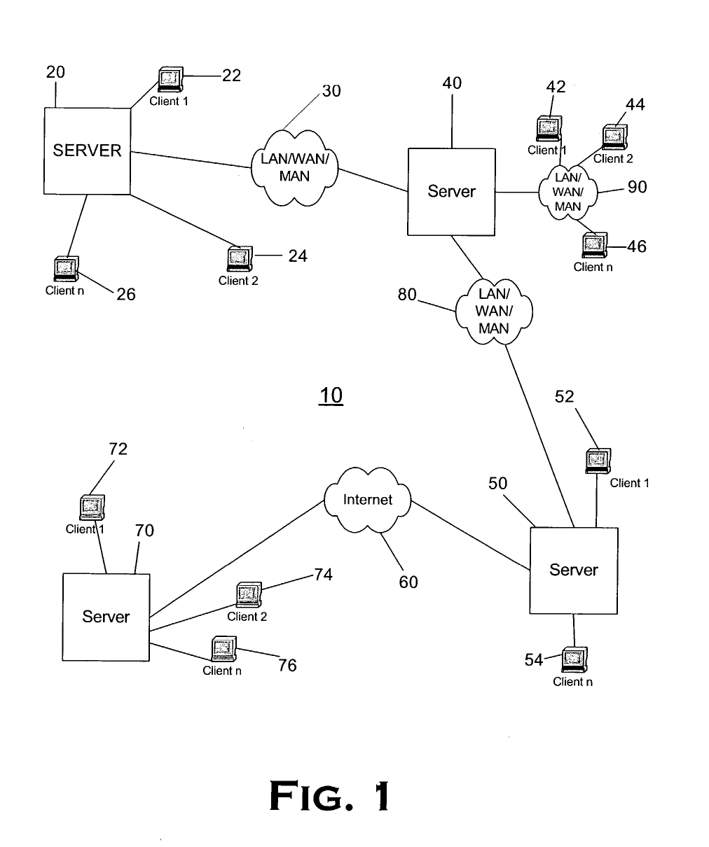

Turning now to the drawings and referring initially to FIG. 1, a block diagram of a computer network architecture is illustrated and designated using a reference numeral 10. A server 20 may be connected to a plurality of client computers 22, 24 and 26. The client computers 22, 24 and 26 may be connected to the server 20 via a network infrastructure, which may include any combination of hubs, switches, routers and the like, which are not shown in FIG. 1 for purposes of clarity.

The server 20 may be connected to as many as “n” different client computers. Each client computer in the network 10 may be a functional client computer. The magnitude of “n” may be a function of the computing power of the server 20. If the server 20 has large computing power (for example, faster processor(s) and/or more system memory), it may be able to serve a number of client computers effectively. The server 20 may be connected via a network infrastructure 30, which may include any combination of hubs, switches, routers and the like. While the network infrastructure 30 is illustrated as being either a local area network (“LAN”), storage area network (“SAN”) a wide area network (“WAN”) or a metropolitan area network (“MAN”), those skilled in the art will appreciate that the network infrastructure 30 may assume other forms or may even provide network connectivity through the Internet. As described below, the network 10 may include other servers, which may be dispersed geographically with respect to each other to support client computers in other locations.

The network infrastructure 30 may connect the server 20 to server 40, which may be representative of any other server in the network environment of server 20. The server 40 may be connected to a plurality of client computers 42, 44, and 46. The client computers 42, 44 and 46 may be connected to the server 20 via a network infrastructure, which may include any combination of hubs, switches, routers and the like, which are not shown in FIG. 1 for purposes of clarity. As illustrated in FIG. 1, a network infrastructure 90, which may include a LAN (including a wireless LAN), a WAN, a MAN, or other network configuration, may be used to connect the client computers 42, 44 and 46 to the server 40. The server 40 may additionally be connected to server 50, which may be connected to client computers 52 and 54. The client computers 52 and 54 may be connected to the server 20 via a network infrastructure, which may include any combination of hubs, switches, routers and the like, which are not shown in FIG. 1 for purposes of clarity. A network infrastructure 80, which may include a LAN, a WAN, a MAN or other network configuration, which may be used to connect the client computers 52, 54 to the server 50. The number of client computers connected to the servers 40 and 50 may depend on the computing power of the servers 40 and 50, respectively.

The server 50 may additionally be connected to the Internet 60, which may be connected to a server 70. The server 70 may be connected to a plurality of client computers 72, 74 and 76. The client computers 72, 74 and 76 may be connected to the server 20 via a network infrastructure, which may include any combination of hubs, switches, routers and the like, which are not shown in FIG. 1 for purposes of clarity. The server 70 may be connected to as many client computers as its computing power may allow.

Those of ordinary skill in the art will appreciate that the servers 20, 40, 50, and 70 may not be centrally located. A network architecture, such as the network architecture 10, may typically result in a wide geographic distribution of computing resources that may be maintained. The servers 20, 40, 50, and 70 may be maintained separately. Also, the client computers illustrated in the network 10 may be subject to maintenance because each may be a functional computer that stores software and configuration settings on a hard drive or elsewhere in memory.

Because of the complexity of the computer network 10, a wide array of problems may occur. For example, autoconfiguration problems may cause segments of the network 10 to operate at less than optimum performance. If autonegotiation errors occur when portions of the network are configured, network switches may be set for incorrect speed and communication type (half-duplex or full-duplex, for instance) with respect to the devices on a given network segment. As set forth above, these autonegotiation errors can significantly degrade network performance.

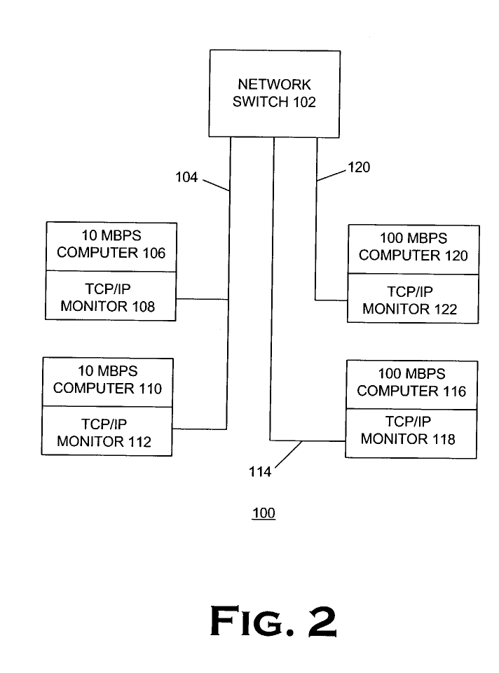

FIG. 2 is a block diagram of a network switch and associated network segments in accordance with an embodiment of the present invention. The diagram is generally referred to by the reference numeral 100. A network switch may be connected to a plurality of network segments in a computer network, such as the computer network 10 (FIG. 1). For purposes of example, the network segments shown in FIG. 2 operate according to the TCP/IP protocol. A first network segment 104 may be a network segment comprising devices operating at a particular speed. In FIG. 2, the network segment 104 is a 10 Mbps network segment. A 10 Mbps computer 106 and a 10 Mbps computer 110 may be connected to the 10 Mbps segment 104. The 10 Mbps computer 106 may be equipped with a TCP/IP monitor 108 and the 10 Mbps computer 110 may be equipped with a TCP/IP monitor 112. The TCP/IP monitors 108 and 112 may be deployed as software, hardware or some combination of the two, and may be located on a NIC within their respective computers. Additionally, the TCP/IP monitors 108 and 112 may be deployed elsewhere, depending on the specific configuration of the network. The TCP/IP monitor 108 monitors the network connection between the 10 Mbps computer 106 and the network switch 102. Similarly, the TCP/IP monitor 108 monitors the network connection between the 10 Mbps computer 106 and the network switch 102.

A network segment 114 may be adapted to operate at a different speed than the network segment 104. For example, the network segment 114 may be adapted to operate at 100 Mbps. A 100 Mbps computer 116 may be connected to the network segment 114. The 100 Mbps computer 116 may include a TCP/IP monitor 118 to monitor various aspects of communication on the network segment 114. The TCP/IP monitor 118 may be deployed as software, hardware, or some combination of the two, and may be located on a NIC within their respective computers. Additionally, the TCP/IP monitor 118 may be deployed elsewhere, depending on the specific configuration of the network.

A network segment 120 may be adapted to operate at a different speed than either the network segment 104 or the network segment 114. In FIG. 2, the network segment is a 100 Mbps network segment. A 100 Mbps computer 120 may be connected to the network segment 120. The 100 Mbps computer 120 may include a TCP/IP monitor 122 to monitor various aspects of communication on the network segment 120. The TCP/IP monitor 122 may be deployed as software, hardware or some combination of the two, and may be located on a NIC within their respective computers. Additionally, the TCP/IP monitor 122 may be deployed elsewhere, depending on the specific configuration of the network.

The TCP/IP protocol was designed to be a very robust protocol. In other words, TCP/IP was designed to self-heal or dynamically work around a wide range of errors and to attempt to overcome those errors during the course of normal operation. For example, TCP/IP is designed to attempt to reroute packets automatically if they become undeliverable through an existing area or segment of the network. Additionally, data may be re-sent a number of times before it is finally received across a damaged or particularly congested network segment. Network performance may be degraded, but the network may still be able to function in the face of a wide range of adverse conditions.

The robustness of TCP/IP means that a TCP/IP network may continue to function with significantly reduced performance if network problems are not identified and resolved. Unfortunately, the ability of TCP/IP to tolerate configuration errors may present difficulty in allowing network problems to be identified and resolved. The performance impact of errors on a specific network or segment may depend on a variety of factors, which may include the particular errors received and how frequently they occur.

TCP/IP devices have the ability to recognize a large number of errors. These errors may include, but are not limited to, the following: duplicate packet errors, duplicate message acknowledgements (acks), out of order packet errors, packets received after close, checksum errors, retransmit timeout errors, persist timeout errors, alignment errors, frames too long, framing checksum (“FCS”) errors, bad header errors, carrier sense errors, packet collisions, late collision errors, excessive collision errors and the like. Error data or statistics, including error type and frequency, may be logged as part of the normal operation of a TCP/IP network. The TCP/IP monitors 108, 112, 118 and 122 may be adapted to collect and analyze information about these error types.

Because configuration of network devices is such a complicated process, most TCP/IP networks may operate with some problems at any given time. This means that a large amount of data about TCP/IP errors that are in fact related to several different performance problems may be generated. The amount of error data and the fact that error data could be from a variety of different network problems may obscure identification of network problems that might otherwise be easily solved. For example, even if a known pattern of errors is associated with a particular performance problem, the known pattern may be masked by the volume of other interfering data. Many errors may have the same root cause (for example, a loose connector on a network cable, incorrect settings on a router or switch somewhere along a data path, bugs in driver software, incorrect LAN switch settings and the like).

The TCP/IP monitors 108, 112, 118 and 122 may be adapted to recognize specific patterns of errors that may be associated with a particular performance problem and alert network support personnel of the existence of that problem. For example, the TCP/IP monitors 108, 112, 118 and 122 may compare TCP/IP error data gathered during normal operation of the network and compare that data to patterns that are known to correspond to certain performance problems or common misconfigurations of networking equipment such as the network switch 102. When a match to a known network problem or configuration error is identified, a notification in the form of an email, a telephone page or the like may automatically be sent to network support personnel who may address the problem.

As discussed previously, one common TCP/IP performance problem is caused by having a mismatch between the settings of the network switch 102 and one or more NICs in computers connected to a particular network segment. For example, a port of the network switch 102 may be set to 10 Mbps half-duplex and a NIC in a computer connected to that port may be set to 100 Mbps full-duplex. As set forth above, this error may be the result of an improper autonegotiation between the network switch 102 and one of more of the NICs connected thereto.

As error statistics are collected and logged as part of the normal operation of a TCP/IP network, that data may be evaluated by the TCP/IP monitors 108, 112, 122 and 118. When one of the TCP/IP monitors 108, 112, 122 or 118 detects the pattern of errors associated with the mismatch between network switch and NIC settings, a notification may be sent to network support personnel, who may reconfigure the settings of the network switch and/or the NICs connected thereto to solve the problem and improve network performance.

The particular set of errors that is associated with the misconfigurations of the speed (half-duplex or full-duplex) of the network switch 102 usually has the following characteristics: a sudden increase in the number of FCS Errors, as well an increase in the number of Alignment Errors. Typically the error counts for these two error types are near zero, even when other errors are occurring (e.g., on a busy networkit is common to have many retransmission and collision errors). However in almost all cases, when an increase in FCS and Alignment errors occurs, it indicates that a protocol mismatch (full/half duplex, 100/10 Mbps) has occurred, and network performance will degrade significantly until the mismatch is corrected.

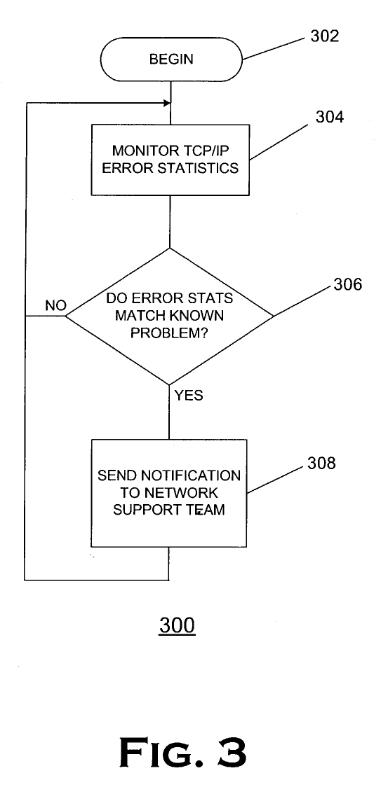

FIG. 3 is a process flow diagram that is useful in explaining the operation of an embodiment of the present invention. The process is generally referred to by the reference numeral 300. At block 302, the process begins. At block 304, a TCP/IP monitor, such as the TCP/IP monitors 108, 112, 122 or 118 (FIG. 2) monitors error statistics for a network segment. The network segment being monitored may be a segment similar to the network segments 104, 114 or 120 (FIG. 2). At block 306, the TCP/IP monitor compares patterns of error statistics to patterns that correspond to known network problems or configuration errors. One of the errors checked for may be to see if there is a mismatch between the communication speed and communication type (half-duplex or full-duplex) of the network switch associated with the network segment being monitored and one or more NICs that may be housed in a computers on that network segment.

If the error statistics do not correspond to a known network performance or configuration problem, monitoring of error statistics may continue at block 304. However, if the TCP/IP monitor identifies a pattern of error statistics corresponding to a known performance or configuration problem, a notification may be sent to members of the support team for the network, as shown at block 308. Monitoring of error statistics may then continue at block 304.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A system for monitoring a computer network that comprises a plurality of computers, the system comprising:
a network monitor associated with each of the plurality of computers, the network monitor being adapted to:
monitor error data for a communication channel;
compare error the data with at least one pattern corresponding to an associated problem; and
provide notification of the associated problem if the error data corresponds to the at least one pattern.

2. The system set forth in claim 1, wherein the communication channel comprises a connection between a network switch and at least one network interface card (“NIC”).

3. The system set forth in claim 2, wherein the associated problem comprises a mismatch between a speed setting associated with the network switch and an operational speed of the at least one NIC.

4. The system set forth in claim 3, wherein the at least one pattern comprises an increase in framing checksum (“FCS”) and alignment errors.

5. The system set forth in claim 1 wherein the communication channel comprises a transmission control protocol/internet protocol (“TCP/IP”) connection.

6. The system set forth in claim 1, wherein the network monitor is adapted to provide the notification of the associated problem by email.

7. A computer network, comprising:
a plurality of computer systems, each of the computer systems being connected to a network switch; and
a network monitor associated with each of the plurality of computers, the network monitor being adapted to:
monitor error data for a communication channel;
compare error data with at least one pattern corresponding to a configuration problem; and
provide notification of the associated configuration problem if the error data corresponds to the at least one pattern.

8. The computer network set forth in claim 7, wherein the communication channel includes a connection between a network switch and at least one network interface card (“NIC”).

9. The computer network set forth in claim 8, wherein the associated configuration problem is a mismatch between a speed setting associated with the network switch and an operational speed of the at least one NIC.

10. The computer network set forth in claim 9, wherein the at least one pattern comprises an increase in framing checksum (“FCS”) and alignment errors.

11. The computer network set forth in claim 7 wherein the communication channel comprises a transmission control protocol/internet protocol (“TCP/IP”) connection.

12. The computer network set forth in claim 7, wherein the network monitor is adapted to provide the notification of the associated configuration problem by email.

13. A method of monitoring a computer network, the method comprising:
monitoring error data associated with a communication channel;
comparing error data with at least one pattern corresponding to an associated problem;
providing notification of the associated problem if the error data corresponds to the at least one pattern.

14. The method set forth in claim 13, comprising defining the communication channel to include a connection between a network switch and at least one network interface card (“NIC”).

15. The method set forth in claim 14, comprising identifying a mismatch between a speed setting associated with the network switch and an operational speed of the at least one NIC.

16. The method set forth in claim 15, wherein the at least one pattern comprises an increase in framing checksum (“FCS”) and alignment errors.

17. The method set forth in claim 13 comprising defining the communication channel to operate according to a protocol known as transmission control protocol/internet protocol (“TCP/IP”).

18. The method set forth in claim 13, comprising providing the notification of the associated problem by email.

19. The method set forth in claim 13, wherein the recited acts are performed in the recited order.

20. A system for monitoring a computer network that comprises a plurality of computers, the system comprising:
means for collecting network data;
means for evaluating the network data to identify a predetermined pattern corresponding to an associated problem; and
means for providing notification of the associated problem if the error data corresponds to the at least one pattern.
